(19) United States
(12) Patent Application Publication
(10) Pub. No.: US 2004/0231608 A1
(43) Pub. Date: Nov. 25, 2004

(54) Livestock watering container with strainer

(76) Inventor: Lisa Grace-Kellogg, Agoura Hills, CA (US)

Correspondence Address: SHELDON & MAK, 9th Floor, 225 South Lake Avenue, Pasadena, CA, 91101, US

(21) Appl. No.: 10/444,601

(22) Filed: May 22, 2003

(51) Int. Cl. A01K 7/00

(52) U.S. Cl. 119/72

(57) ABSTRACT

A liquid container combination has a container for retaining a liquid and a strainer disposed within the container. The container has generally vertical side walls and a top wall opening. The strainer is typically disposed below the water level within the container.

### FIELD OF THE INVENTION

This invention relates generally to liquid container combinations and, more specifically, to liquid container combinations suitable for watering livestock and other animals.

### BACKGROUND OF THE INVENTION

It is common to water animals, such as horses, from a large container, such as from a large water bucket. The problem with the use of such large containers is that the water within the container quickly becomes fouled with hay and other foreign material. Unless such foreign material is promptly removed from the water, the water will go bad and make the animals ill.

Such drinking containers, however, are typically large and very heavy when filled with water. Accordingly, it is difficult to frequently change the water within the container.

Accordingly, there is a need for a liquid container which avoids the aforementioned problems in the prior art.

### SUMMARY OF THE INVENTION

The invention satisfies this need. The invention is a liquid container combination suitable for watering animals. The liquid container combination comprises (a) a container for retaining a liquid having a volumetric capacity of at least about 4 ounces, the container having a bottom wall and one or more side walls terminating at their uppermost positions in an upper side wall periphery, the upper side wall periphery defining a top wall opening, and (b) a basket strainer for allowing the movement of liquid there across but for preventing the movement of certain solid materials there across, the strainer having a bottom wall and one or more side walls, the strainer having a mesh size of between about 0.015 square inches and about 0.6 square inches, the strainer being nested within the container such that the bottom wall of the strainer is proximate to the bottom wall of the container and such that the one or more side walls of the strainer are proximate to the one or more side walls of the container.

In another embodiment, the liquid container combination comprises (a) a container for retaining a liquid having a volumetric capacity of at least about 4 ounces, the container having a bottom wall and one or more side walls, the one or more side walls having a vertical height 1 and terminating at their uppermost portions in an upper side wall periphery, the upper side wall periphery defining a top wall opening, and (b) a strainer for allowing the movement of liquid there across but for preventing the movement of certain solid materials there across, the strainer having a mesh size of between about 0.015 square inches and about 0.6 square inches, the strainer being disposed in a substantially horizontal strainer plane, the strainer plane being located below the top wall opening by a distance of between about 50% 1 and about 100% 1.

### DESCRIPTION OF THE DRAWINGS

These and other features, aspects and advantages of the present invention will become better understood with reference to the following description, appended claims and accompanying drawings where:

FIG. 1 is a front view of a first liquid container combination having features of the invention;

FIG. 2 is a front view of a second liquid container combination having features of the invention; and

FIG. 3 is a cross-sectional side view of the liquid container combination illustrated in FIG. 2.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is a liquid container combination 10 comprising a container 12 and a strainer 14.

The container 12 has a bottom wall 16 and one or more side walls 18. The one or more side walls 18 have a vertical height 1 which terminate at their uppermost portions in an upper side wall periphery 20. The upper side wall periphery 20 defines a top wall opening 22.

The container 12 has a volumetric capacity to match the particular livestock being watered with the container combination. For very small animals, the container 12 can be as small as about 4 ounces. For larger animals, the container 12 typically has a volumetric capacity of between about 5 quarts and about 50 quarts. For a typical container 12 suitable for the watering of horses, the height 1 of the vertical side walls 18 is typically between about 12 inches and about 20 inches and the container 12 typically has a volumetric capacity of between about 10 quarts and about 20 quarts, most typically between about 15 quarts and about 19 quarts.

The container 12 can be readily made from plastic, metal or any other suitable material.

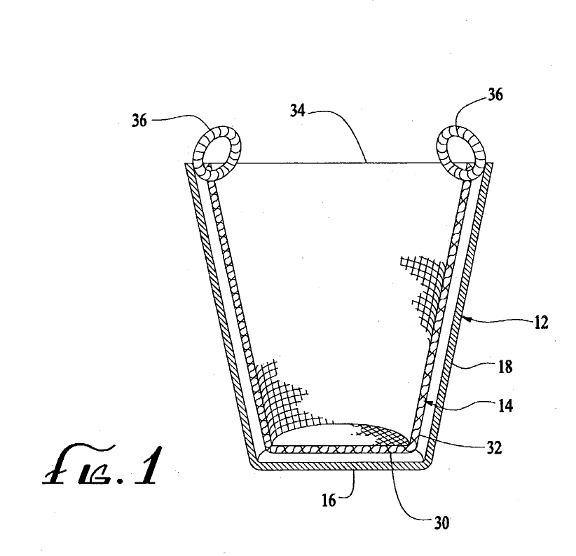

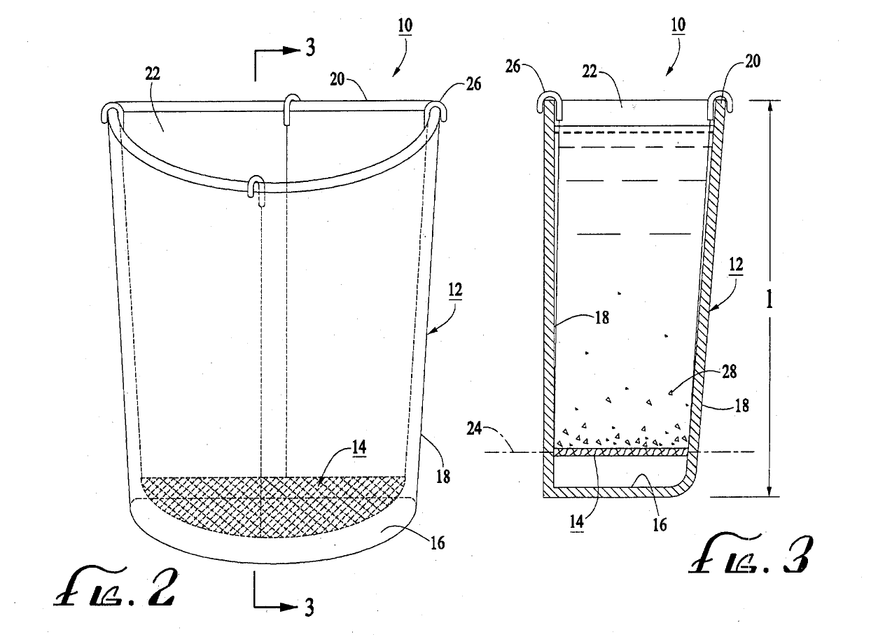

In a preferred embodiment, the strainer 14 is a basket strainer, that is, strainer 14 is shaped like a basket having a bottom wall 30, one or more side walls 32 and a top opening 34. Such a basket strainer is illustrated in FIG. 1. In another embodiment, the strainer 14 is planar in shape as illustrated in FIGS. 2 and 3.

In a typical embodiment, the strainer 14 comprises a mesh having a plurality of squares, each square being between about ⅛ inch and about ¾ inch, most typically about ½ inch. Thus, the mesh size is typically between about 0.015 square inches and about 0.6 square inches, typically about 0.25 square inches. The strainer 14 is adapted to allow liquid to flow across the strainer 14 but to prevent the movement of certain solid materials across the strainer 14.

The strainer 14 can also be made from plastic, metal or other suitable material.

When the strainer 14 is a basket strainer, the strainer 14 is nested within the container 12, such that the bottom wall 30 of the strainer 14 is proximate to the bottom wall 16 of the container 12 and such that the one or more side walls 32 of the strainer 14 are proximate to the one or more side walls 18 of the container 12. The strainer walls 30 and 32 are typically in abutment with the walls 16 and 18 of the container 12, but this is not necessary. One or more of the strainer walls 30 and 32 can be slightly spaced apart from the walls 16 and 18 of the container 12.

As illustrated in FIG. 1, handles 36 can be disposed near the top of the one or more side walls 32 of the strainer 14 to allow the user to conveniently remove the strainer 14 from the container 12.

In the embodiment illustrated in FIGS. 2 and 3, the strainer 14 is disposed in a substantially horizontal strainer plane 24 within the container 12. The strainer plane 24 is typically located above the bottom wall 16 of the container 12 and below the water line within the container 12. Typically, the strainer plane 24 is disposed between about 50% 1 and about 100% 1 below the bottom wall opening 22.

In the embodiment illustrated in FIGS. 2 and 3, the strainer 14 is typically disposed at the strainer plane 24 by suspension from a plurality of hooks 26, each hook 26 being attached to the upper side wall periphery 20. The use of the plurality of hooks 26 allows the user to easily remove the strainer 14 and the container 12 by lifting up on the hooks 26. Other means for attaching the strainer 14 at the strainer plane 24 can also be used.

In operation, the user fills the container 12 with clean water and then places the strainer 14 within the container 12 at the strainer plane 24 below the water level. After the container 12 is used by animals for drinking, any hay or other large foreign material 28 within the container 12 can be simply and easily removed from the container 12 by merely lifting the strainer 14 out of the container 12. As the strainer 14 is lifted out of the container 12, hay and other large foreign material 28 is captured along the upper surface of the strainer 14 and is removed from the container 12 with the strainer 14.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A liquid container combination suitable for watering animals, the liquid container combination comprising:
(a) a container for retaining a liquid having a volumetric capacity of at least about 4 ounces, the container having a bottom wall and one or more side walls terminating at their uppermost positions in an upper side wall periphery, the upper side wall periphery defining a top wall opening; and
(b) a basket strainer for allowing the movement of liquid there across but for preventing the movement of certain solid materials there across, the strainer having a bottom wall and one or more side walls, the strainer having a mesh size of between about 0.015 square inches and about 0.6 square inches, the strainer being nested within the container such that the bottom wall of the strainer is proximate to the bottom wall of the container and such that the one or more side walls of the strainer are proximate to the one or more side walls of the container.

2. The liquid container combination of claim 1 wherein the container has a volumetric capacity of between about 10 qts. and about 20 qts.

3. The liquid container combination of claim 1 wherein the container has a volumetric capacity of between about 15 qts. and about 19 qts.

4. The liquid container combination of claim 1 wherein the mesh of the strainer comprises a plurality of squares and has a mesh size of between about ⅛ inch and about ¾ inch.

5. A liquid container combination suitable for watering animals, the liquid container combination comprising:
(a) a container for retaining a liquid having a volumetric capacity of at least about 15 qts., the container having a bottom wall and one or more side walls terminating at their uppermost positions in an upper side wall periphery, the upper side wall periphery defining a top wall opening; and
(b) a basket strainer for allowing the movement of liquid there across but for preventing the movement of certain solid materials there across, the strainer having a bottom wall and one or more side walls, the strainer having a mesh size of between about 0.015 square inches and about 0.6 square inches, the strainer being nested within the container such that the bottom wall of the strainer is proximate to the bottom wall of the container and such that the one or more side walls of the strainer are proximate to the one or more side walls of the container.

6. The liquid container combination of claim 5 wherein the container has a volumetric capacity of between about 15 qts. and about 19 qts.

7. The liquid container combination of claim 5 wherein the mesh of the strainer comprises a plurality of squares and has a mesh size of between about ⅛ inch and about ¾ inch.

8. A liquid container combination suitable for watering animals, the liquid container combination comprising:
(a) a container for retaining a liquid having a volumetric capacity of at least about 4 ounces, the container having a bottom wall and one or more side walls, the one or more side walls having a vertical height 1 and terminating at their uppermost portions in an upper side wall periphery, the upper side wall periphery defining a top wall opening; and
(b) a strainer for allowing the movement of liquid there across but for preventing the movement of certain solid materials there across, the strainer having a mesh size of between about 0.015 square inches and about 0.6 square inches, the strainer being disposed in a substantially horizontal strainer plane, the strainer plane being located below the top wall opening by a distance of between about 50% 1 and about 100% 1.

9. The liquid container combination of claim 8 wherein the strainer is disposed in a substantially horizontal strainer plane located above the bottom wall of the container.

10. The liquid container combination of claim 8 wherein the strainer is planar in shape.

11. The liquid container combination of claim 8 wherein the strainer is suspended from the upper side wall periphery.

12. The liquid container combination of claim 8 wherein the strainer is suspended from the upper side wall periphery by hooks.

13. The liquid container combination of claim 8 wherein the container has a volumetric capacity of between about 10 qts. and about 20 qts.

14. The liquid container combination of claim 8 wherein the container has a volumetric capacity of between about 15 qts. and about 19 qts.

15. The liquid container combination of claim 8 wherein the mesh size of the strainer comprises a plurality of squares and has a mesh size of between about ⅛ inch and about ¾ inch.

16. The liquid container combination of claim 8 wherein the side wall height 1 is between about 12 inches and about 20 inches and wherein the strainer is disposed in a plane between about 11 inches and about 19 inches below the top wall opening.
